(19) United States
(12) Patent Application Publication
(10) Pub. No.: US 2020/0301106 A1
(43) Pub. Date: Sep. 24, 2020

(54) LENS OPTICAL SYSTEM AND PHOTOGRAPHING DEVICE

(71) Applicant: ACE SOLUTECH CO., LTD.

(72) Inventors: Pil Sun JUNG, Gyeonggi-do (KR); Dong Young KIM, Gyeonggi-do (KR); Chi Ho AN, Gyeonggi-do (KR)

(21) Appl. No.: 16/086,207

(22) PCT Filed: Mar. 21, 2017
(86) PCT No.: PCT/KR2017/002996

§ 371 Date: Sep. 18, 2018

(30) Foreign Application Priority Data
Mar. 22, 2016 (KR) 10-2016-0033987

(51) Int. Cl. G02B 9/64; G02B 5/20; H04N 5/335

(52) U.S. Cl. CPC G02B 9/64; H04N 5/335; G02B 5/20

(57) ABSTRACT

Provided are a lens optical system and a photographing device including the lens optical system. The lens optical system includes first to eighth lenses that are sequentially arranged from an object side toward an image plane side and respectively have negative, negative, positive, positive, positive, negative, positive, and positive refractive powers. The lens optical system may satisfy an ultra-wide-angle condition: 130≤FOV≤240, where FOV (unit: °) refers to the field of view of the lens optical system.

This application is the National Stage of International Application No. PCT/KR2017/002996, having an International Filing Date of 21 Mar. 2017, which designated the United States of America, and which International Application was published under PCT Article 21(2) as WO Publication No. 2017/164607 A1, which claims priority from and the benefit of Korean Patent Application No. 10-2016-0033987, filed on 22 Mar. 2016, the disclosures of which are incorporated herein by reference in their entireties.

### BACKGROUND

### 1. Field

The present disclosure relates to a lens optical system and a photographing device.

### 2. Description Of Related Developments

Recently, the use and application of cameras including solid-state photographing elements such as complementary metal oxide semiconductor (CMOS) image sensors or charge coupled devices (CCDs) have greatly increased.

In addition, the degree of pixel integration in solid-state photographing elements has increased to improve the resolution of cameras. Along with this, cameras have been developed to be small and lightweight by improving the performance of lens optical systems included in the cameras. Such cameras are suitable for size reduction, and thus, may be applied to various action-cams such as drones or camcorders for leisure or sports activities, to automobiles having functions such as forward monitoring, backward monitoring, lane recognition, and autonomous driving, in addition to being applied to mobile devices such as smartphones.

Such cameras require ultra-wide-angle lenses according to application fields such as action-cams or automobiles. In addition, such cameras should have high resolutions to cope with high pixel counts and are required to have compact sizes for high portability.

### SUMMARY

The present disclosure provides a lens optical system and a photographing device that are compact so as to be included in a small device such as a cellular phone and are capable of capturing images at an ultra-wide angle.

According to an aspect of the present disclosure, a lens optical system, sequentially from an object side to an image plane side, includes: a first lens having a negative (−) refractive power; a second lens having a negative (−) refractive power; a third lens having a positive (+) refractive power; a fourth lens having a positive (+) refractive power; a fifth lens having a positive (+) refractive power; a sixth lens having a negative (−) refractive power; a seventh lens having a positive (+) refractive power; and an eighth lens having a positive (+) refractive power, wherein the lens optical system satisfies the following condition:

130≤FOV≤240 Condition 1

where FOV (unit: °) refers to a field of view of the lens optical system.

The lens optical system may satisfy the following condition:

0.15≤(L1toL2)/OAL≤0.4 Condition 2

where L1toL2 (unit: mm) refers to a distance between a center of an entrance surface of the first lens and a center of an exit surface of the second lens, OAL (unit: mm) refers to a distance between the center of the entrance surface of the first lens and a center of an exit surface of the eighth lens.

The lens optical system may further include an aperture stop between the third lens and the fourth lens.

The lens optical system may satisfy the following condition:

0≤ThiL5L6≤0.03 Condition 3

where ThiL5L6 refers to a distance between a center of an exit surface of the fifth lens and a center of an entrance surface of the sixth lens.

The fifth lens and the sixth lens may form a doublet lens.

The doublet lens may have a negative (−) refractive power.

The lens optical system may satisfy at least one of the following conditions:

0.7≤Ind1/Ind3≤1.4 Condition 4

1.4≤Abv1/Abv3≤3.0 Condition 5

0.7≤Ind5/Ind6≤1.4 Condition 6

1.4≤Abv5/Abv6≤3.0 Condition 7

where Ind1, Ind3, Ind5, and Ind6 respectively refer to refractive indexes of the first lens, the third lens, the fifth lens, and the sixth lens, and Abv1, Abv3, Abv5, and Abv6 respectively refer to Abbe numbers of the first lens, the third lens, the fifth lens, and the sixth lens.

The first lens may have an exit surface concave toward the image plane side.

The second lens may have an exit surface concave toward the image plane side.

The fifth lens may have an exit surface convex toward the image plane side.

The sixth lens may have an entrance surface concave toward the object side.

The seventh lens may be an aspherical lens.

At least one of the first to eighth lenses may be a glass lens.

The first lens may have a meniscus shape with an entrance surface convex toward the object side.

According to another aspect of the present disclosure, a lens optical system may include a front lens group, an aperture stop, and a rear lens group that are sequentially arranged from an object side toward an image plane side, wherein the front lens group may include a first lens having an exit surface concave toward the image plane side, a second lens having an exit surface concave toward the image plane side, and a third lens having a positive (+) refractive power, wherein the rear lens group may include a fourth lens having a positive (+) refractive power, a fifth lens having an exit surface convex toward the image plane side, a sixth lens having an entrance surface concave toward the object side, a seventh lens having a positive (+) refractive power, and an eighth lens having a positive (+) refractive power, wherein the lens optical system may satisfy the following condition:

130≤FOV≤240 Condition 1′

where FOV (unit: °) refers to a field of view of the lens optical system.

The front lens group may satisfy the following condition:

0.15≤(L1toL2)/OAL≤0.4 Condition 2′

where L1toL2 (unit: mm) refers to a distance between a center of an entrance surface of the first lens and a center of the exit surface of the second lens, OAL (unit: mm) refers to a distance between the center of the entrance surface of the first lens and a center of an exit surface of the eighth lens.

The fifth lens and the sixth lens may form a doublet lens having a negative refractive power.

The first lens may have a negative (−) refractive power, the second lens may have a negative (−) refractive power, the fifth lens may have a positive (+) refractive power, and the sixth lens may have a negative (−) refractive power.

According to another aspect of the present disclosure, a photographing device may include: the lens optical system; and a solid-state photographing element configured to capture an image formed by the lens optical system.

The lens optical system and the photographing device of the present disclosure may have an ultra-wide field of view while being compact for use in a small device such as an action-cam or an automotive camera.

### BRIEF DESCRIPTION OF DRAWINGS

FIG. 1 is a cross-sectional view schematically illustrating an arrangement of main elements of a lens optical system according to a first embodiment of the present disclosure.

FIG. 2 is an aberration diagram illustrating spherical aberration, astigmatic field curves, and distortion of the lens optical system of the first embodiment.

FIG. 3 is a cross-sectional view schematically illustrating an arrangement of main elements of a lens optical system according to a second embodiment of the present disclosure.

FIG. 4 is an aberration diagram illustrating spherical aberration, astigmatic field curves, and distortion of the lens optical system of the second embodiment.

FIG. 5 is a cross-sectional view schematically illustrating an arrangement of main elements of a lens optical system according to a third embodiment of the present disclosure.

FIG. 6 is an aberration diagram illustrating spherical aberration, astigmatic field curves, and distortion of the lens optical system of the third embodiment; and

FIG. 7 is a schematic perspective view illustrating a photographing device including a lens optical system, according to an embodiment.

### DETAILED DESCRIPTION

Hereinafter, lens optical systems and photographing devices will be described according to embodiments of the present disclosure with reference to the accompanying drawings. In the drawings, like reference numerals refer to like (or similar) elements.

In the following description, the term “image plane” refers to a plane on which images are formed by light passing through a lens optical system, and the term “image plane side” may refer to a side at which a photographing element such as an image sensor is located or a direction toward the side. The term “object side” may refer to a side opposite the “image plane side” based on the lens optical system. In addition, a surface of a lens facing the object side may be referred to as an entrance surface, and the other surface of the lens facing the image plane side may be referred to as an exit surface.

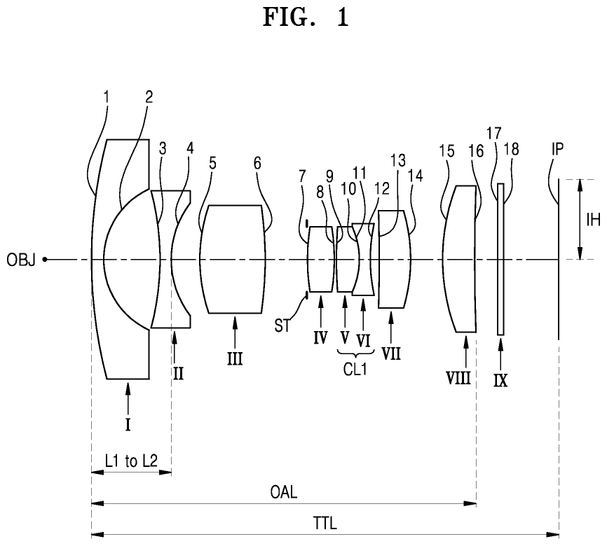

FIG. 1 is a schematic cross-sectional view illustrating an arrangement of elements of a lens optical system according to a first embodiment.

The lens optical system includes a front lens group, an aperture stop ST, and a rear lens group that are sequentially arranged in a direction from an object (OBJ) side toward an image plane (IP) side. The front lens group and the rear lens group may be distinguished based on the aperture stop ST. If the aperture stop ST is not used, the front lens group and the rear lens group may be distinguished based on a fixed aperture stop surface that controls light rays.

For example, the front lens group may include a first lens I having a negative (−) refractive power, a second lens II having a negative (−) refractive power, and a third lens III having a positive (+) refractive power.

For example, the first lens I may have an exit surface 2 concave toward the IP side. For example, the first lens I may have an entrance surface 1 convex toward the OBJ side. In other words, the first lens I may have a meniscus shape convex toward the OBJ side.

For example, the second lens II may have an exit surface 4 concave toward the IP side. For example, the second lens II may have an entrance surface 3 concave toward the OBJ side. In other words, the second lens II may have a biconcave shape.

For example, the third lens III may have an exit surface 6 convex toward the IP side. For example, the third lens III may have an entrance surface 5 convex toward the OBJ side. In other words, the third lens III may have a biconvex shape.

For example, the rear lens group may include a fourth third lens IV having a positive (+) refractive power, a fifth lens V having a positive (+) refractive power, a sixth lens V having a negative (−) refractive power, a seventh lens VI having a positive (+) refractive power, and an eighth lens VIII having a positive (+) refractive power.

For example, the fourth lens IV may have an exit surface 8 convex toward the IP side. For example, the fourth lens IV may have an entrance surface 7 convex toward the OBJ side. In other words, the fourth lens IV may have a biconvex shape.

For example, the fifth lens V may have an exit surface 10 convex toward the IP side. For example, the fifth lens V may have an entrance surface 9 convex toward the OBJ side. In other words, the fifth lens V may have a biconvex shape.

For example, the sixth lens VI may have an exit surface 12 concave toward the IP side. For example, the sixth lens VI may have an entrance surface 11 concave toward the OBJ side. In other words, the sixth lens VI may have a biconcave shape.

For example, the seventh lens VII may have an exit surface 14 convex toward the IP side. For example, the seventh lens VII may have an entrance surface 13 concave toward the OBJ side. In other words, the seventh lens VII may have a meniscus shape convex toward the IP side.

For example, the eighth lens VIII may have an exit surface 16 concave toward the IP side. For example, the eighth lens VIII may have an entrance surface 15 convex toward the OBJ side. In other words, the eighth lens VIII may have a meniscus shape concave toward the IP side.

The above-described refractive power distribution of the front lens group and the rear lens group may make it easy to control chromatic aberration. In addition, according to the embodiment, since the aperture stop ST is placed between the front lens group and the rear lens group, the optical power of the lens optical system may be distributed in such a manner that the lens optical system may have a sufficient degree of performance at an ultra wide angle of view.

At least one optical filter IX may be provided between the eighth lens VIII and the IP. For example, the optical filter IX may include at least one of low-pass filters, infrared (IR)-cut filters, and cover glass. For example, if the optical filter IX includes an IR-cut filter, visible rays may pass through the optical filter VII but infrared rays may not pass through the optical filter VII. Thus, infrared rays may not reach the IP. However, the lens optical system may not include the optical filter IX.

For example, the front lens group and the rear lens group may include at least one aspherical lens. For example, the seventh lens VII may be an aspherical lens. For example, the first to seventh lenses I to VII may be spherical lenses. For example, all of the first to eighth lenses I to VIII may be spherical lenses.

According to embodiments of the present disclosure, in the lens optical system having the above-described configuration, at least one of the first to eighth lenses I to VIII may include glass. For example, all of the first to sixth lenses I to VI may be manufactured using glass. As described above, if glass lenses are used, owing to high optical reliability, aspherical surfaces may be applied to the glass lenses, thereby obtaining various effects by the aspherical surfaces such as total length reduction, compact shaping, aberration correction, or high performance. However, materials of the first to eighth lenses I to VIII are not limited to glass. If necessary, at least one of the first to eighth lenses I to VIII may be manufactured using a plastic material. Plastic lenses may be lighter and more advantageous for mass production than glass lenses. Some of the first to eighth lenses I to VIII may be glass lenses, and the others of the first to eighth lenses I to VIII may be plastic lenses.

The lens optical system of the embodiment may satisfy the following condition:

130≤FOV≤240 Condition 1

where FOV (unit: °) refers to the field of view of the lens optical system.

The lens optical system of the embodiment may be an ultra-wide-angle lens optical system as described above and may have a small size as shown in a numerical embodiment described later. Thus, the lens optical system may be easily applied to devices such as automotive lenses, action-cams, or surveillance cameras.

The lens optical system of the embodiment may satisfy the following condition.

0.15≤(L1toL2)/OAL≤0.4 Condition 2

where L1toL2 (unit: mm) refers to the distance between the center of the entrance surface of the first lens and the center of the exit surface of the second lens, OAL (unit: mm) refers to the distance between the center of the entrance surface of the first lens and the center of the exit surface of the eighth lens.

Condition 2 is for imparting high performance to the lens optical system while maintaining ultra-wide-angle performance of the lens optical system. According to Condition 2, the total thickness of the first and second lenses I and II may be limited relative to the total thickness of the lenses of the lens optical system.

The fifth lens V and the sixth lens VI may satisfy the following condition.

0≤ThiL5L6≤0.03 Condition 3

where ThiL5L6 refers to the distance between the center of the exit surface of the fifth lens V and the center of the entrance surface of the sixth lens VI.

Condition 3 indicates that the fifth lens V and the sixth lens VI are joined together to form a doublet lens CL1 or are very close to each other. That is, the exit surface 10 of the fifth lens V and the entrance surface 11 of the sixth lens VI may be substantially the same surface (joined surfaces) or may be surfaces very close to each other. The aberration of the lens optical system may be reduced by joining the fifth lens V and the sixth lens VI.

The doublet lens CL1 made up of the fifth lens V and the sixth lens VI may have a negative (−) refractive power. The joined surfaces (that is, 10/11) of the fifth lens V and the sixth lens VI may be spherical. In other words, the exit surface 10 of the fifth lens V and the entrance surface 11 of the sixth lens VI may be spherical.

The lens optical system of the embodiment may satisfy at least one of the following conditions.

0.7≤Ind1/Ind3≤1.4 Condition 4

1.4≤Abv1/Abv3≤3.0 Condition 5

0.7≤Ind5/Ind6≤1.4 Condition 6

1.4≤Abv5/Abv6≤3.0 Condition 7

where Ind1, Ind3, Ind5, and Ind6 respectively refer to the refractive indexes of the first lens, the third lens, the fifth lens, and the sixth lens, and Abv1, Abv3, Abv5, and Abv6 respectively refer to the Abbe numbers of the first lens, the third lens, the fifth lens, and the sixth lens.

In the lens optical system satisfying Condition 4, the first lens is a relatively low-refractive-index lens, and the third lens a relatively high-refractive-index lens.

The lens optical system satisfying Condition 5 may have low chromatic aberration when configured as an ultra-wide-angle lens system because the Abbe number of the first lens is relatively large and the Abbe number of the third lens is relatively small.

In the lens optical system satisfying Condition 6, the fifth lens is a relatively low-refractive-index lens, and the sixth lens a relatively high-refractive-index lens.

The lens optical system satisfying Condition 7 may have low chromatic aberration when configured as an ultra-wide-angle lens system because the Abbe number of the fifth lens is relatively large and the Abbe number of the sixth lens is relatively small.

In the description of the lens optical system of the embodiment of the present disclosure, the term “aspherical” or “aspherical surface” has the following definition.

When an optical axis is set as an x-axis, a direction perpendicular to the optical axis is set as a y-axis, and the propagation direction of rays is denoted as a positive direction, an aspherical surface of a lens may be defined by the following equation. In the equation, x denotes a distance measured from the vertex of a lens in the direction of the optical axis of the lens, y denotes a distance measured from the optical axis in a direction perpendicular to the optical axis, K denotes a conic constant, A, B, C, D, E, and F denote aspherical coefficients, and c′ denotes the reciprocal (1/R) of the radius of curvature at the vertex of the lens.

### Aspherical Surface Equation

$$x = \frac{{c}^{′} {y}^{2}}{1 + \sqrt{1 - ( K + 1 ) {c}^{′2} {y}^{2}}} + {Ay}^{4} + B 6 + {Cy}^{8} + {Dy}^{10} + {Ey}^{12} + {Fy}^{14}$$

Variously designed lens optical systems may be provided according to numerical embodiments as described below.

In each numerical embodiment, lens surfaces are sequentially numbered in a direction from an OBJ side to an IP side (1, 2, 3, . . . , n where n is an natural number), and these lens surface numbers are illustrated in the accompanying drawings. In addition, OBJ refers to an object, F-no refers to an F-number, FOV refers to a field of view, R refers to a radius of curvature, Dn refers to a lens thickness or an air gap between lenses, Nd refers to a refractive index, and Vd refers to an Abbe number. In addition, ST refers to an aperture stop, and * refers to an aspherical surface.

### First Numerical Embodiment

FIG. 1 illustrates a lens optical system according to a first numerical embodiment, and design data for the lens optical system of the first numerical embodiment are shown in Table 1 below.

TABLE 1

| | Surfaces | R | D | Nd | Vd |
|---|---|---|---|---|---|
| I | 1 | 23.38500 | 0.60000 | 1.56384 | 60.82920 |
| | 2 | 3.80800 | 2.86382 | | |
| II | 3 | #NAME? | 0.55000 | 1.48749 | 70.44016 |
| | 4 | 4.55000 | 1.44673 | | |
| | ST | 8.42000 | 3.28000 | 1.80610 | 33.26885 |
| III | 5 | −19.36400 | 2.09794 | | |
| | 6 | Infinity | 0.03000 | | |
| IV | 7 | 10.14000 | 1.36000 | 1.83500 | 42.98355 |
| | 8 | −10.14000 | 0.10000 | | |
| V | 9 | 26.01400 | 1.15000 | 1.51680 | 64.19733 |
| | 10 | −3.95400 | 0.00000 | | |
| VI | 11 | −3.95400 | 0.55000 | 1.84666 | 23.78440 |
| | 12 | 9.04320 | 0.45388 | | |
| VII | 13 | −64.31000 | 1.59000 | 1.83500 | 42.98355 |
| | 14 | −8.31000 | 1.59829 | | |
| VIII | 15 | 9.98800 | 1.61000 | 1.83500 | 42.98355 |
| | 16 | 99.00000 | 1.17242 | | |
| IX | 17 | Infinity | 0.30000 | 1.51432 | 64.16641 |
| | 18 | Infinity | 2.77061 | | |
| | IP | Infinity | −0.00162 | | |

In the lens optical system according to the first numerical embodiment, first to eighth lenses may be spherical lenses. In other words, all the aspherical coefficients A, B, C, D, E, and F of the first to eighth lenses may be zero.

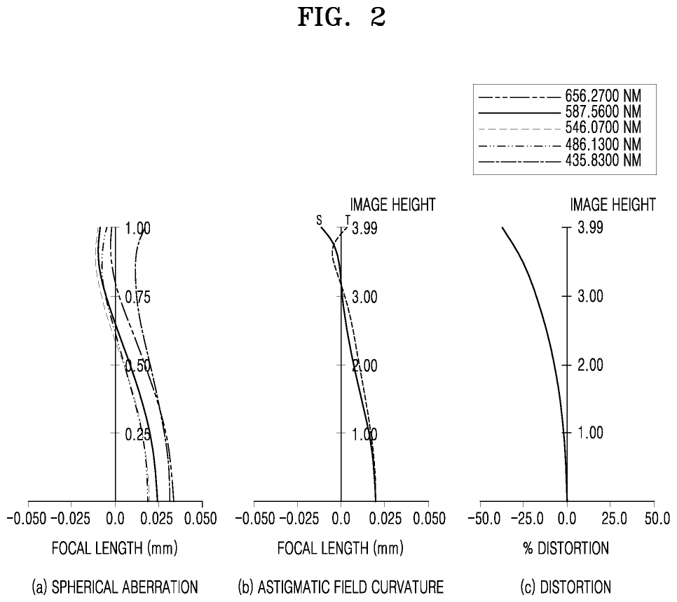

FIG. 2 illustrates longitudinal spherical aberration, astigmatic field curves, and distortion of the lens optical system of the first numerical embodiment. The astigmatic field curves include a tangential field curvature T and a sagittal field curvature S.

### Second Numerical Embodiment

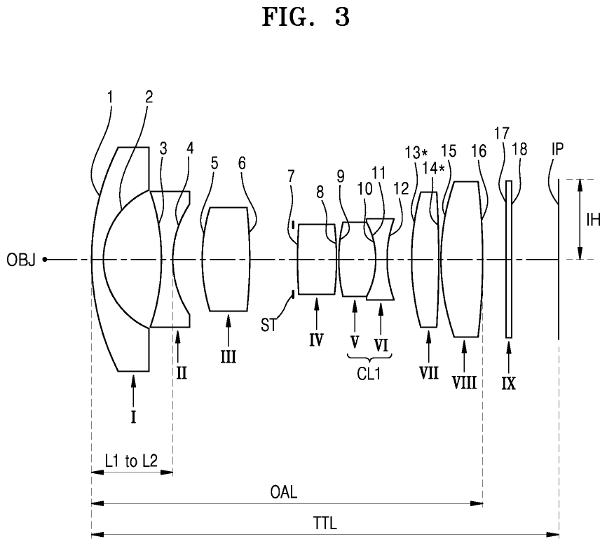

FIG. 3 illustrates a lens optical system according to a second numerical embodiment, and design data for the lens optical system of the second numerical embodiment are shown in the following table.

TABLE 2

| | Surfaces | R | D | Nd | Vd |
|---|---|---|---|---|---|
| I | 1 | 12.25000 | 0.60000 | 1.71300 | 53.93805 |
| | 2 | 3.77900 | 2.93555 | | |
| II | 3 | −10.54000 | 0.55000 | 1.48749 | 70.44016 |
| | 4 | 4.95200 | 1.50476 | | |
| | ST | 9.04600 | 2.38000 | 1.80610 | 33.26885 |
| III | 5 | −21.34200 | 2.18239 | | |
| | 6 | Infinity | 0.20000 | | |
| IV | 7 | 16.20400 | 2.00000 | 1.79950 | 42.33945 |
| | 8 | −13.18900 | 0.10000 | | |
| V | 9 | 8.22000 | 1.86000 | 1.69680 | 55.45887 |
| | 10 | −3.95400 | 0.00000 | | |
| VI | 11 | −3.95400 | 0.55000 | 1.78470 | 26.10250 |
| | 12 | 5.73700 | 1.23749 | | |
| VII | 13* | 11.27638 | 1.37255 | 1.58913 | 61.20027 |
| | 14* | −99.00000 | 0.11932 | | |
| VIII | 15 | 11.54200 | 2.09000 | 1.80611 | 40.73371 |
| | 16 | −33.10800 | 1.17242 | | |
| IX | 17 | Infinity | 0.30000 | 1.51432 | 64.16641 |
| | 18 | Infinity | 2.34638 | | |
| | IP | Infinity | −0.00076 | | |

The following table shows aspherical coefficients in the second numerical embodiment.

TABLE 3

| Surfaces | K | A | B | C | D | E | F |
|---|---|---|---|---|---|---|---|
| 1 | | | | | | | |
| 2 | | | | | | | |
| 3 | | | | | | | |
| 4 | | | | | | | |
| 5 | | | | | | | |
| 6 | | | | | | | |
| 7 | | | | | | | |
| 8 | | | | | | | |
| 9 | | | | | | | |
| 10 | | | | | | | |
| 11 | | | | | | | |
| 12 | | | | | | | |
| 13* | −30.84533 | 0.00166 | −0.00016 | 0.00001 | 0.00000 | 0.00000 | 0.00000 |
| 14* | 0.00000 | −0.00024 | 0.00000 | 0.00000 | 0.00000 | 0.00000 | 0.00000 |
| 15 | | | | | | | |
| 16 | | | | | | | |

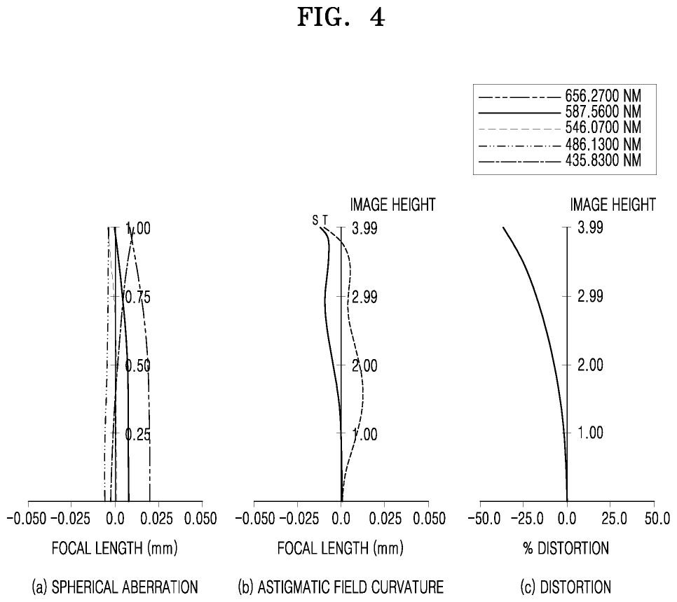

FIG. 4 illustrates longitudinal spherical aberration, astigmatic field curves, and distortion of the lens optical system of the second numerical embodiment.

### Third Numerical Embodiment

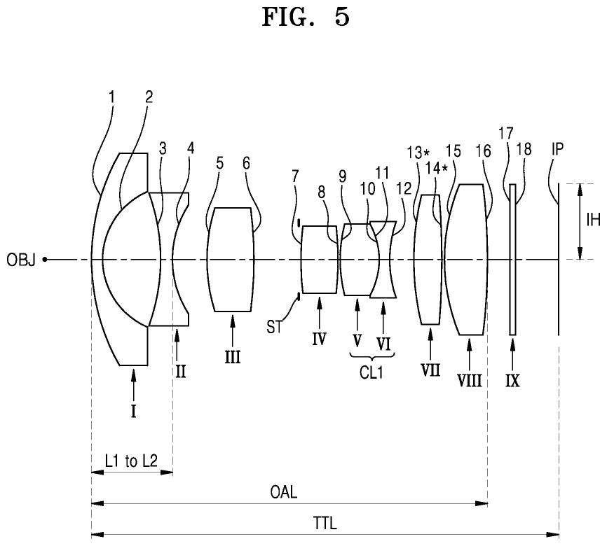

FIG. 5 illustrates a lens optical system according to a third numerical embodiment, and design data for the lens optical system of the third numerical embodiment are shown in the following table.

TABLE 4

| | Surfaces | R | D | Nd | Vd |
|---|---|---|---|---|---|
| I | 1 | 11.31000 | 0.60000 | 1.77250 | 49.62353 |
| | 2 | 3.90600 | 3.10685 | | |
| II | 3 | −10.08500 | 0.60000 | 1.48749 | 70.44016 |
| | 4 | 5.21700 | 1.84029 | | |
| | ST | 9.00400 | 2.52000 | 1.80610 | 33.26885 |
| III | 5 | −20.00000 | 2.40884 | | |
| | 6 | Infinity | 0.10000 | | |
| IV | 7 | 20.00000 | 1.98000 | 1.78590 | 43.93370 |
| | 8 | −15.80000 | 0.10000 | | |
| V | 9 | 7.67500 | 2.07000 | 1.71300 | 53.93805 |
| | 10 | −4.04600 | 0.00000 | | |
| VI | 11 | −4.04600 | 0.55000 | 1.80518 | 25.45598 |
| | 12 | 5.73900 | 1.30068 | | |
| VII | 13* | 11.66000 | 1.50743 | 1.58913 | 61.20027 |
| | 14* | −99.00000 | 0.13039 | | |
| VIII | 15 | 10.34900 | 2.29000 | 1.72342 | 37.99348 |
| | 16 | −34.31200 | 1.19955 | | |
| IX | 17 | Infinity | 0.30000 | 1.51432 | 64.16641 |
| | 18 | Infinity | 2.28594 | | |
| | IP | Infinity | −0.00172 | | |

The following table shows aspherical coefficients in the third numerical embodiment.

TABLE 5

| Surfaces | K | A | B | C | D | E | F |
|---|---|---|---|---|---|---|---|
| 1 | | | | | | | |
| 2 | | | | | | | |
| 3 | | | | | | | |
| 4 | | | | | | | |
| 5 | | | | | | | |
| 6 | | | | | | | |
| 7 | | | | | | | |
| 8 | | | | | | | |
| 9 | | | | | | | |
| 10 | | | | | | | |
| 11 | | | | | | | |
| 12 | | | | | | | |
| 13 | −32.07406 | 0.00126 | −0.00014 | 0.00001 | 0.00000 | 0.00000 | 0.00000 |
| 14 | 0.00000 | −0.00060 | 0.00000 | 0.00000 | 0.00000 | 0.00000 | 0.00000 |
| 15 | | | | | | | |
| 16 | | | | | | | |

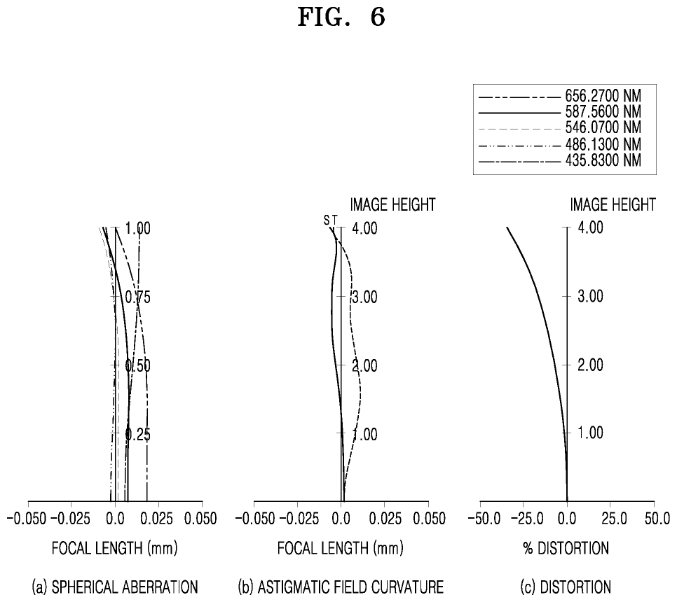

FIG. 6 illustrates longitudinal spherical aberration, astigmatic field curves, and distortion of the lens optical system of the third numerical embodiment.

In addition, the F-number (Fno), focal length (f), and field of view (FOV) of each of the lens optical systems of the first to third numerical embodiments are shown in Table 6 below.

TABLE 6

| | F-number | Focal length | Field of view |
|---|---|---|---|
| Embodiments | (Fno) | (f) [mm] | (FOV) [°] |
| First embodiment | 2.38 | 3.36 | 155.75 |
| Second embodiment | 2.38 | 3.22 | 155.60 |
| Third embodiment | 2.28 | 3.32 | 150.76 |

The following table shows that the lens optical systems of the first to third numerical embodiments satisfy Conditions 1 to 7. In Table 7, FOV denotes a field of view in degrees (°).

TABLE 7

| | | First | Second | Third |
|---|---|---|---|---|
| Conditions | Inequalities | embodiment | embodiment | embodiment |
| Condition 1 | 130 ≤ Fov ≤ 240 | 155.75 | 155.60 | 150.76 |
| Condition 2 | 0.15 ≤ (L1toL2)/OAL ≤ 0.4 | 0.21 | 0.21 | 0.20 |
| Condition 3 | 0 ≤ ThiL5L6 ≤ 0.03 | 0.00 | 0.00 | 0.00 |
| Condition 4 | 0.7 ≤ Ind1/Ind3 ≤ 1.4 | 0.87 | 0.95 | 0.98 |
| Condition 5 | 1.4 ≤ Abv1/Abv3 ≤ 3.0 | 1.83 | 1.62 | 1.49 |
| Condition 6 | 0.7 ≤ Ind5/Ind6 ≤ 1.4 | 0.82 | 0.95 | 0.95 |
| Condition 7 | 1.4 ≤ Abv5/Abv6 ≤ 3.0 | 2.70 | 2.12 | 2.12 |

Table 8 shows values of variables used to obtain data shown in Table 7. In Table 8, values of TTL, IH, L1toL2, and OAL are in millimeters (mm). Here, TTL (unit: mm) refers to the distance from the center of the entrance surface of the first lens to the IP, and IH (unit: mm) refers to an image height by the effective diameter of the lens optical system.

TABLE 8

| Conditions | First embodiment | Second embodiment | Third embodiment |
|---|---|---|---|
| TTL | 23.50 | 23.50 | 24.89 |
| IH | 7.98 | 7.98 | 8.00 |
| L1toL2 | 4.014 | 4.086 | 4.307 |
| OAL | 19.28 | 19.68 | 21.10 |
| Ind1 | 1.564 | 1.713 | 1.773 |
| Ind3 | 1.806 | 1.806 | 1.806 |
| Ind5 | 1.517 | 1.697 | 1.713 |
| Ind6 | 1.847 | 1.785 | 1.805 |
| Abv1 | 60.829 | 53.938 | 49.624 |
| Abv3 | 33.269 | 33.269 | 33.269 |
| Abv5 | 64.197 | 55.459 | 53.938 |
| Abv6 | 23.784 | 26.102 | 25.456 |

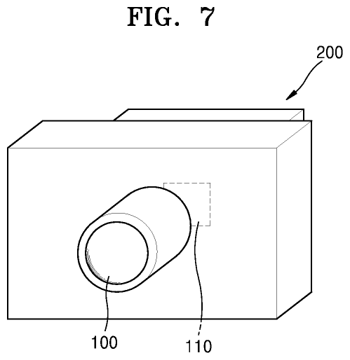

FIG. 7 is a view illustrating a photographing device 200 including a lens optical system 100 according to an embodiment. The photographing device 200 may include: the lens optical system 100; and an image sensor 110 configured to convert images formed by the lens optical system 100 into electric image signals. The lens optical system 100 may be any one of the lens optical systems described with reference to FIGS. 1 to 6. The lens optical systems of the above-described embodiments may be applied to various photographing devices such as action-cams including drones and camcorders for leisure or sports activities. In this manner, photographing devices having an ultra wide angle and capable of high-performance photographing may be provided.

The photographing device illustrated in FIG. 7 is merely a general example. That is, application to various optical devices is possible. For example, the lens optical system of the current embodiment may be used as a lens optical system of an automotive camera, a surveillance camera, or the like. For example, the lens optical system of the current embodiment may be applied to various automotive devices such as black boxes, around view monitoring (AVM) systems, or rear cameras. The lens optical system of the current embodiment may also be applied to cameras for mobile phones. In addition, the lens optical system of the current embodiment may be applied to devices such as virtual reality devices or augmented reality devices. For example, the lens optical systems of the above-described embodiments may be oriented in opposite directions in virtual reality device.

Although many specific features have been described, these features should be considered in a descriptive sense only and not for purposes of limitation. That is, such features should be considered as examples according to embodiments. For example, it will be apparent to those of ordinary skill in the art that although the shapes of the lenses of the lens optical systems of the embodiments of the present disclosure are modified to some degree, the above-described effects can be obtained when the lens optical systems satisfy at least one of Conditions 1 to 7. In addition, although the lens optical systems do not satisfy some of Conditions 1 to 7, when the distribution of the refractive powers of the lenses, the structural conditions of the lenses, and other conditions are satisfied, the above-described effects may be obtained. Other various embodiments may be provided. Thus, the scope and spirit of the present disclosure are defined not by the descriptions of the embodiments but by the appended claims.

The lens optical system and the photographing device of the present disclosure may be applied to various action-cams such as drones or camcorders for leisure or sports activities, and automotive devices for forward monitoring, backward monitoring, lane recognition, and autonomous driving, in addition to being applied to mobile devices such as smartphones.

What is claimed is:

1. A lens optical system, sequentially from an object side to an image plane side, comprising:
a first lens having a negative (−) refractive power;
a second lens having a negative (−) refractive power;
a third lens having a positive (+) refractive power;
a fourth lens having a positive (+) refractive power;
a fifth lens having a positive (+) refractive power;
a sixth lens having a negative (−) refractive power;
a seventh lens having a positive (+) refractive power; and
an eighth lens having a positive (+) refractive power,
wherein the lens optical system satisfies the following condition:
130≤FOV≤240 Condition 1
where FOV (unit: °) refers to a field of view of the lens optical system.

2. The lens optical system of claim 1, wherein the lens optical system satisfies the following condition:
0.15≤(L1toL2)/OAL≤0.4 Condition 2
where L1toL2 (unit: mm) refers to a distance between a center of an entrance surface of the first lens and a center of an exit surface of the second lens, OAL (unit: mm) refers to a distance between the center of the entrance surface of the first lens and a center of an exit surface of the eighth lens.

3. The lens optical system of claim 1, further comprising an aperture stop between the third lens and the fourth lens.

4. The lens optical system of claim 1 or 2, wherein the lens optical system satisfies the following condition:
0≤ThiL5L6≤0.03 Condition 3
where ThiL5L6 refers to a distance between a center of an exit surface of the fifth lens and a center of an entrance surface of the sixth lens.

5. The lens optical system of claim 1, wherein the fifth lens and the sixth lens forms a doublet lens.

6. The lens optical system of claim 5, wherein the doublet lens has a negative (−) refractive power.

7. The lens optical system of claim 1 or 2, wherein the lens optical system satisfies at least one of the following conditions:
0.7≤Ind1/Ind3≤1.4 Condition 4
1.4≤Abv1/Abv3≤3.0 Condition 5
0.7≤Ind5/Ind6≤1.4 Condition 6
1.4≤Abv5/Abv6≤3.0 Condition 7
where Ind1, Ind3, Ind5, and Ind6 respectively refer to refractive indexes of the first lens, the third lens, the fifth lens, and the sixth lens, and Abv1, Abv3, Abv5, and Abv6 respectively refer to Abbe numbers of the first lens, the third lens, the fifth lens, and the sixth lens.

8. The lens optical system of claim 1, wherein the first lens has an exit surface concave toward the image plane side.

9. The lens optical system of claim 1, wherein the second lens has an exit surface concave toward the image plane side.

10. The lens optical system of claim 1, wherein the fifth lens has an exit surface convex toward the image plane side.

11. The lens optical system of claim 1, wherein the sixth lens has an entrance surface concave toward the object side.

12. The lens optical system of claim 1, wherein the seventh lens is an aspherical lens.

13. The lens optical system of claim 1, wherein at least one of the first to eighth lenses is a glass lens.

14. The lens optical system of claim 1, wherein the first lens has a meniscus shape with an entrance surface convex toward the object side.

15. A lens optical system comprising a front lens group, an aperture stop, and a rear lens group that are sequentially arranged from an object side toward an image plane side,
wherein the front lens group comprises a first lens having an exit surface concave toward the image plane side, a second lens having an exit surface concave toward the image plane side, and a third lens having a positive (+) refractive power,
wherein the rear lens group comprises a fourth lens having a positive (+) refractive power, a fifth lens having an exit surface convex toward the image plane side, a sixth lens having an entrance surface concave toward the object side, a seventh lens having a positive (+) refractive power, and an eighth lens having a positive (+) refractive power, wherein the lens optical system satisfies the following condition:
130≤FOV≤240 Condition 1′
where FOV (unit: °) refers to a field of view of the lens optical system.

16. The lens optical system of claim 15, wherein the front lens group satisfies the following condition:
0.15≤(L1toL2)/OAL≤0.4 Condition 2′
where L1toL2 (unit: mm) refers to a distance between a center of an entrance surface of the first lens and a center of the exit surface of the second lens, OAL (unit: mm) refers to a distance between the center of the entrance surface of the first lens and a center of an exit surface of the eighth lens.

17. The lens optical system of claim 15, wherein the fifth lens and the sixth lens form a doublet lens having a negative refractive power.

18. The lens optical system of claim 15, wherein the first lens has a negative (−) refractive power.

19. The lens optical system of claim 18, wherein the second lens has a negative (−) refractive power, the fifth lens has a positive (+) refractive power, and the sixth lens has a negative (−) refractive power.

20. A photographing device comprising: the lens optical system of claim 1; and a solid-state photographing element configured to capture an image formed by the lens optical system
